(19) United States
(12) Patent Application Publication
(10) Pub. No.: US 2003/0093494 A1
(43) Pub. Date: May 15, 2003

(54) Interactive application note and method of supporting electronic components within a virtual support system

(76) Inventors: Ilia Zverev, Munchen (DE); Marco Purschel, Munchen (DE); Antoine Fery, Amiens (FR)

Correspondence Address: LERNER AND GREENBERG, P.A., Post Office Box 2480, Hollywood, FL, 33022-2480, US

(21) Appl. No.: 09/999,383

(22) Filed: Oct. 31, 2001

(51) Int. Cl. G06F 15/16

(52) U.S. Cl. 709/217; 709/220

(57) ABSTRACT

Electronic components such as semiconductor chips are supported by the manufacturer by providing product developers an online catalogue with the electronic components that are available from the manufacturer. The novel support system links information typically provided on data sheets with application-specific information. The user is prompted to input the application-specific parameters in an interactive application note and the system provides information concerning the electronic component in the specific application context. The virtual support system thus provides interactive application notes with a detailed product description in a specific application context and with interactive entry fields, in addition to static data sheets and static application notes.

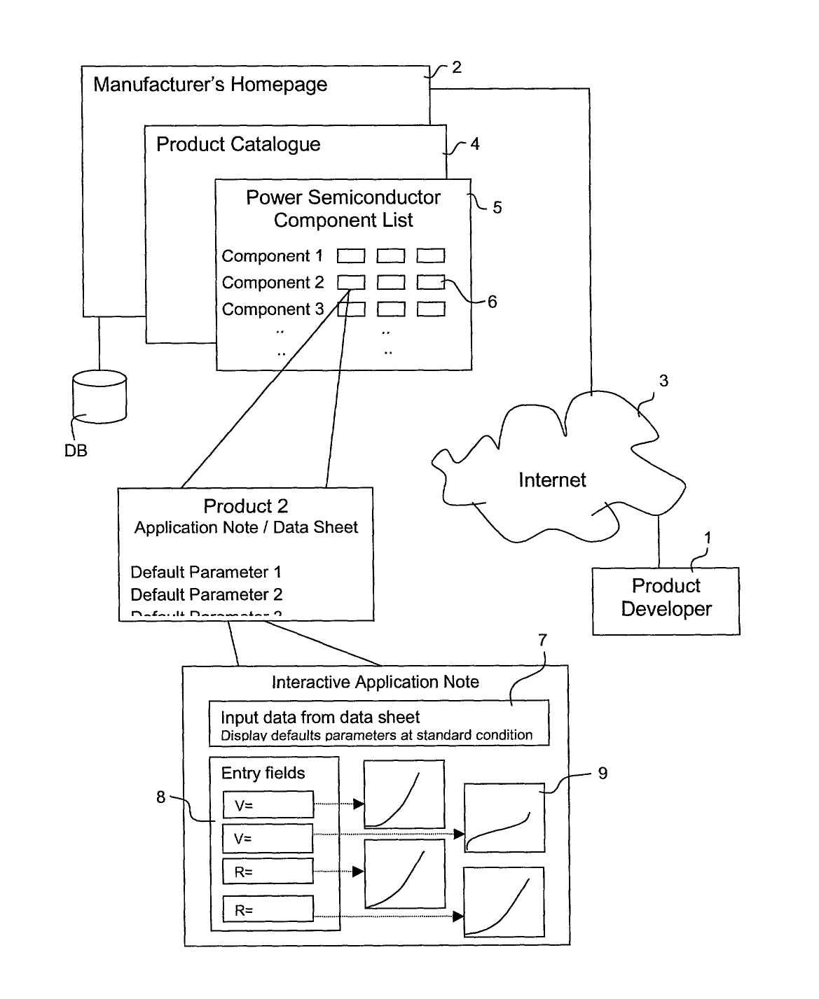

### BACKGROUND OF THE INVENTION

1. Field of the Invention

The invention lies in the product support field for electronic components. The invention pertains to circuit design and development and relates, specifically, to a business model and system of providing product support for electronic components. The invention relates to a business model which aids in shortening and simplifying design cycles for electronic and electrical component integration.

Modern business models concerning innovations and product development often include as one of the primary parameters so-called “time to market” considerations. This is particularly true in the fast-developing and highly competitive electronics field. New developments in the high-tech area are subject to substantial design and development costs, which typically include constructing and testing a prototype.

Time to market considerations are especially acute in power electronics, which is subject to considerable price pressures.

Time savings during the design phase of current supplies, and the like, often determine the competitiveness of a producer.

Conversely, electronic components and their interactive cooperation become increasingly complicated. Those component manufacturers that provide more support place themselves at an advantage in this competitive field. In general terms, the necessary support is conventionally provided in the form of data sheets, application notes, calculation programs, and simulation models. This information is typically available via the Internet.

In order to minimize the design phase expenditures, product developers increasingly utilize these available support sources. A series of application-dependent iteration steps can thereby be avoided in the development of an optimized circuit. The result is an immediate savings in time.

Infineon Technologies, as one of the premier power semiconductor manufacturers, provides a vast array of product and application support. For instance, the Infineon homepage (http://www.infineon.com) lists a variety of support sources for its high-voltage power transistors, namely, data sheets or specification sheets, simulation models, and a slew of application notes.

These support categories are still subject to considerable efforts by the application designer. On the one hand, data sheets and application notes are entirely static and, on the other hand, simulation models and calculation programs require substantial amounts of work in inputting the necessary information.

### SUMMARY OF THE INVENTION

It is accordingly an object of the invention to provide a component support system and method, which overcomes the above-mentioned disadvantages of the heretofore-known devices and methods of this general type and which provides for yet shorter and more efficient design phases during the integration of power semiconductors.

With the above and other objects in view there is provided, in accordance with the invention, a method of providing technical support for an electronic component, which comprises:

providing a catalogue with a plurality of electronic components and prompting a user to choose at least one electronic component;

providing an interactive application note concerning the at least one electronic component, the interactive application note containing information selected from a data sheet for the at least one electronic component and from a static application note for the at least one electronic component;

prompting the user to enter application-specific parameters and outputting application-specific information concerning the at least one electronic component.

It should be understood that the above method steps may be broken up in terms of their time sequence. For example, in case the interactive application note is provided for download or on a separate data file carrier, the step in which the user selects from the catalog of available products and the step in which the user is prompted for input may be completely separate in time and location.

In accordance with an added feature of the invention, the catalogue is an online catalogue provided via the Internet.

In accordance with an additional feature of the invention, the electronic component is a semiconductor component and the application-specific information includes topology-specific load parameters of the at least one electronic component.

With the above and other objects in view there is also provided, in accordance with the invention, a virtual product support system, comprising:

a computer-readable file with a listing of electronic components;

a storage system storing files representing data sheets for the electronic components;

an input system enabling a user to input application-specific information;

a computer-executable file containing a program for calculating an electronic behavior of the electronic components based on information from the data sheets and from the application-specific information input by the user; and

an output system for outputting application-specific behavior of the electronic components.

In accordance with another feature of the invention, the input system and the output system are configured through a network connection, such as the World Wide Web of the Internet.

In accordance with a concomitant feature of the invention, the listing of the electronic components is hyperlinked to the computer-executable file.

In order to properly understand the various terms used herein, the following categories must be distinguished:

Data sheets provide the consumer, i.e., the hardware product designer, static and dynamic parameters for the electronic components within defined measurement applications. Data sheets are static information sources.

Application notes are passive documents—typically PDF files (Adobe® Acrobat®)—with information concerning the application of the semiconductor components. Application notes discuss typical applications of the semiconductors, the behavior characteristics of the component in typical applications and they explain maximum design parameters. Application notes are static information sources.

Simulation models are computer files which contain the data information necessary for complex simulation programs such as, for instance, SABER® and Pspice®.

Calculation programs are programs which are specifically focused on the application. They are used to calculate application-specific design parameters such as the transfer ratio of a transformer or component-specific parameters such as a maximum Rdson. These calculation programs are always and exclusively provided together with a detailed description or application note.

The foregoing conventional support tools still require the product designer to utilize several mutually independent information sources, the hardware designer must know how to use the various support tools and he or she must be conversant in all of the four support systems in order to maximally and optimally utilize the semiconductor component within the circuit to be designed.

This is where the advantages of the instantly claimed invention become immediately obvious. The model described herein further optimizes customer support and it provides optimum support for the hardware developer in that the novel type of application note is interactive instead of static. The interactive application note thus provides a further auxiliary means which bridges the pure simulation programs with the data sheets and other static support materials. The interactive application note in fact renders the simulation model on the one hand and the static application note and data sheets on the other hand superfluous in many situations during the initial design phases. Especially in relatively simple circuits, such as a power supply, will it be possible to proceed through the final development stages virtually exclusively on the basis of the interactive application note.

The interactive application note thus provides for a novel support tool which essentially combines the conventional information sources. The interactive application note combines essential elements of the data sheets (e.g. Rdson or thermal boundary resistances) with application-based elements from the application notes (e.g. topology-typical load parameters for the components). Within the above-defined categories, the interactive application note is a type of simulation tool with focus on the specific application.

The advantage to be gained by the hardware designer is an additional information source that is specifically optimized towards the hardware development. The interactive input elements of the application note enable optimized targeting of the specific application and the various output fields display the results for the specifically addressed problem.

Other features which are considered as characteristic for the invention are set forth in the appended claims.

Although the invention is illustrated and described herein as embodied in a support system and a method of providing product support for an electronic circuit component, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWING

The sole figure is a block diagram providing an overview of the novel system in which an interactive application note is accessible over the Internet.

### DESCRIPTION OF THE PREFERRED EMBODIMENTS

Referring now to the figure of the drawing in detail, there is seen a diagrammatic box 1 representing a product developer. The developer is in the preliminary stages of developing a hardware element such as, for instance, a simple power supply. In his research, the product developer accesses the manufacturer's homepage 2 via the Internet 3. The developer 1 is particularly interested in a power transistor. In only a few clicks within the manufacturer's home page, the developer 1 arrives at a product catalogue 4 and then at a listing 5 of power transistors of interest.

The listing 5 contains a variety of labels 6, each representing a hyperlink to one of the support systems. These include links to specific data sheets, application notes, simulation models, and calculation programs. All of these are available in a protected data base DB at the manufacturer's server. In accordance with the invention, the application notes provided here are interactive. That is, upon clicking the link to a given interactive application note, the developer 1 is prompted for specific parameters.

The interactive application note first of all provides measurement results for the dynamic behavior of the power transistors. The dependencies of the switching energies, both for turn-on and for turn-off, on the load current, the drain to source voltage, and the gate resistance are taken into consideration. The developer 1 can adapt these to his specific circuit.

On entering the specific application note for a given component, the display starts at typical default values. By way of example, the display may show, at a window 7, the on-resistance at 25° C., a formula for the on-resistance as a function of the junction temperature, and the thermal resistance at the switch junction. A further window 8 prompts the user to enter applicable parameters and the component behavior is graphed at windows 9 on the basis of the parameters. For example, the displays 9 may graph the switching energy over the drain to source voltage and the gate resistance as a function of the peak current.

Based on these measurement results and interpolation steps, the interactive application note continues to show how to calculate total losses in the transistor. Overviews of which transistor fits which application best or, say, how large the heat sink cooler needs to be dimensioned, provide the developer the necessary hands-on information and advantageous hints that help in the development of circuit.

In a second embodiment of the invention, the focus of the interactive application note lies in the simulation of current and voltage behavior in switched mode power supply topologies such as switching regulators and converters. The simulation results are generated from mathematical, physical relationships, such as the Kirchhoff rules. Commutation rules are also taken into account as defined by various leakage inductances of the transformer.

In a first display screen, the application note provides all of the pertinent equations in variable form. For instance, there is displayed a complete formula for the primary current, the secondary equivalent current, the magnetizing current, the output current, the drain to source transistor voltage, and the magnetizing voltage.

The user can then input various design parameters for a given topology in a further input screen. The design parameters may include the switching frequency, the output power, and the output voltage. From these, the system calculates switching times and commutation times, as well as maximum, minimum, and effective voltages, currents, and powers.

In yet a further screen or window, the interactive application note displays graphs of additional simulation results, such as voltage and current curves. The screen may graph, for instance, transformer currents, rectified currents, and magnetizing and transistor voltages. The graphs are recalculated in real time upon any change of the input parameters. Convergence problems and extraneous calculation times are reduced.

In a currently preferred embodiment, the calculation subprograms of the interactive application note are written in the program MathCAD. Other programs may be utilized as well, and the system may be assembled as an executable standalone file or it may be provided as a call-up routine. In the former case, the executable file may be provided on a computer-readable data medium, i.e., for download (so that the product developer need not be connected to the Internet at the time of running the program) or on a separate data file carrier.

We Claim

1. A method of providing technical support for an electronic component, which comprises:
providing a catalogue with a plurality of electronic components and prompting a user to choose at least one electronic component;
providing an interactive application note concerning the at least one electronic component, the interactive application note containing information selected from a data sheet for the at least one electronic component and from a static application note for the at least one electronic component;
prompting the user to enter application-specific parameters and outputting application-specific information concerning the at least one electronic component.

2. The method according to claim 1, wherein the catalogue is an online catalogue provided via the Internet.

3. The method according to claim 1, wherein the electronic component is a semiconductor component and the application-specific information includes topology-specific load parameters of the at least one electronic component.

4. A virtual product support system, comprising:
a computer-readable file with a listing of electronic components;
a storage system storing files representing data sheets for the electronic components;
an input system enabling a user to input application-specific information;
a computer-executable file containing a program for calculating an electronic behavior of the electronic components based on information from the data sheets and from the application-specific information input by the user; and
an output system for outputting application-specific behavior of the electronic components.

5. The virtual product support system according to claim 4, wherein said input system and said output system are configured through a network connection.

6. The virtual product support system according to claim 5, wherein said network connection is configured through the Internet.

7. The virtual product support system according to claim 4, wherein said listing of the electronic components is hyperlinked to said computer-executable file.
